(19) United States
(12) Patent Application Publication
(10) Pub. No.: US 2003/0021574 A1
(43) Pub. Date: Jan. 30, 2003

(54) Optical fiber positioning structure and semiconductor laser module

(76) Inventors: Yukio Inokuchi, Ibaraki (JP); Hirofumi Uchida, Ibaraki (JP)

Correspondence Address: ARMSTRONG,WESTERMAN & HATTORI, LLP, 1725 K STREET, NW., SUITE 1000, WASHINGTON, DC, 20006, US

(21) Appl. No.: 10/189,172

(22) Filed: Jul. 5, 2002

Related U.S. Application Data
(63) Continuation of application No. PCT/JP01/09688, filed on Nov. 6, 2001.

(30) Foreign Application Priority Data
Nov. 6, 2000 (JP) 2000-337866
Apr. 10, 2001 (JP) 2001-111029
Apr. 25, 2001 (JP) 2001-127287

(51) Int. Cl. G02B 6/00

(52) U.S. Cl. 385/137; 385/49

(57) ABSTRACT

The optical fiber positioning structure of the present invention is provided with a fiber support member 11 permitting the holding of an optical fiber 9 in a fiber coupling 22, and a pedestal 3 supporting fiber support member 11. An indentation 25 having a depth permitting downward movement of the optical fiber is formed in pedestal 3. Optical fiber 9 is held in a state ensuring space at least above and below by fiber coupling 22. During positioning of the optical fiber, the opposite side from the end of the optical fiber being positioned is moved vertically to rotate the optical fiber about a rotation center at a point near the end being positioned, permitting fine movement of the end being positioned.

### TECHNICAL FIELD

The present invention relates to a structure for positioning the input end or connection end of an optical fiber.

### PRIOR ART

In semiconductor laser modules comprising a semiconductor laser and an optical fiber, it is necessary to efficiently optically couple the laser beam emitted by the semiconductor laser to the optical fiber. Since optical coupling efficiency is greatly affected by even slight displacement of the front end of the optical fiber, during the manufacturing stage, precise positioning of the optical fiber and securing it in position in a manner preventing displacement during use are important.

To facilitate handling, the portion of an optical fiber close to the semiconductor laser is often encased in a metal part known as a ferrule. FIG. 5(a) shows a conventional semiconductor laser module 101 employing an optical fiber in such a form. In the present Specification, the portion of the optical fiber including the ferrule is referred to as the “optical fiber” (or simply “fiber”), and the diameter including the ferrule portion is referred to as the “optical fiber diameter”. In the conventional example shown in FIG. 5(a), an optical fiber 109 is placed solidly on a pedestal 103, and so as to form a holding region corresponding to the diameter of optical fiber 109, a metal fiber gripping member 111 bent in an inverted “U” shape is slipped over the optical fiber from above and secured by laser welding so that optical fiber 109 is completely prevented from moving.

However, in this design, when there is vertical displacement (strictly speaking, displacement in the direction perpendicular to the surface on which pedestal 103 is mounted; in the conventional module shown in the figure and in the implementation modes of the present invention described further below, pedestal 3 is positioned horizontally, making this direction the vertical) of the optical axis in optical fiber 109 after laser welding, since optical fiber 109 is tightly attached to pedestal 103, there is a problem in that the metal ferrule of optical fiber 109 ends up striking pedestal 103, precluding vertical adjustment of the position of fiber 109.

Accordingly, to avoid this problem, the holding structure 201 shown in FIG. 5(b) was devised. In this conventional example, the middle bent portion of fiber holding member 211 is extended upward, with space being provided between optical fiber 209 and pedestal 203 for vertical positioning of optical fiber 209. To further facilitate positioning of optical fiber 209, the rigidity of fiber holding member 211 is reduced to the extent possible.

However, although reducing the rigidity of fiber holding member 211 facilitates positioning of optical fiber 209, it also creates a problem in that the position in which optical fiber 209 is held changes due to the heat cycle, aging, or change in fiber holding member 211 over time. In particular, the holding position quite often shifts vertically with respect to the pedestal. Shifting in a direction parallel to the pedestal, that is, horizontal shifting, occurs quite rarely but creates quite peculiar problems.

Further, as shown in FIG. 5(c), when adjusting the vertical position of optical fiber 209, since the center of rotation “O” is located far from the axis of optical fiber 209, optical fiber 209 is difficult to control. Further, since optical fiber 209 ends up moving forward or backward during vertical positioning of optical fiber 209, there is a problem in that the input end of optical fiber 209 strikes against the semiconductor laser light source positioned in front of it.

Optical fiber positioning structures are disclosed in U.S. Pat. Nos. 5,963,695, 6,184,987, 5,570,444, and 5,619,609, but there remains room for improvement.

The present invention takes a fresh look at the configurations of the fiber support member and the pedestal, the positional relation between the two, and the joining position of the fiber support member and the optical fiber to avoid the problems inherent in the holding structure of the above-described conventional optical fiber with the object of providing both a novel and useful positioning structure for an optical fiber in which fine positioning of the optical fiber is facilitated, and a semiconductor laser module incorporating this structure.

### SUMMARY OF THE INVENTION

To achieve the above-stated object, the present inventors conducted extensive research, resulting in the discovery that, in addition to forming a space for vertical positioning of the optical fiber, by vertically displacing the opposite side from the end of the optical fiber being positioned, rotation was possible about a point near the end being positioned, permitting minute displacement adjustment of the end being positioned. In particular, in forming a space for vertical positioning of the optical fiber, it was discovered that, instead of increasing the height of the fiber coupling of the fiber support member, the space could be formed by forming an indentation in a portion of the pedestal. It was also discovered that by vertically rotating the optical fiber on the side opposite from the end being positioned, minute adjustment was possible on the end being positioned. The present invention was devised on this basis.

That is, the optical fiber positioning structure of the present invention is characterized in that a fiber support member capable of holding an optical fiber in a fiber coupling and a pedestal supporting said fiber support member are provided, there being in said pedestal an indentation having a depth permitting said optical fiber to move downward, said optical fiber being held in said fiber coupling in a state ensuring space at least above and below, and it being possible to move the side opposite the end of the optical fiber being positioned vertically to rotate about a rotation center at a point near said end being positioned and displace by minute amounts said end being positioned.

Further, in the above-described invention, said rotation center may be provided on the axis of the optical fiber or in the vicinity thereof.

Further, in the above-described invention, two fiber support members may be positioned on said pedestal along the axis of said optical fiber, the fiber holding support member on the side near the input end or connection end of said optical fiber holding in a nearly fixed manner the position of the optical fiber, and the fiber holding support member furthest from the input end or connection end of said optical fiber holding said optical fiber during positioning of the optical fiber in a manner permitting displacement of the optical fiber (Mode 2).

Further, in the above-described invention, an elastic action flex member may be formed in the fiber support member on the far side from the input end or connection end of the optical fiber between a fixation member and the fiber coupling (Mode 3).

Further, in the above-described invention, the fixation members of the fiber support members may be fixed through a pedestal joint on the two sides of the indentation relative to the optical fiber axis (Mode 4).

Further, the height of the fiber coupling of the fiber support member as viewed from the bottom surface of the fixation members of the fiber support members may be set to be less than or equal to, preferably less than or equal to ⅔, and more preferably less than or equal to ½, the diameter of the optical fiber. In particular, the axis of the optical fiber may be positioned lower than the upper surface of the fixation member of the fiber support member (Mode 5). Further, in Mode 5, the axis of the optical fiber is desirably positioned higher than the bottom surface of the fixation member of the fiber support member.

Further, in the above-described invention, the optical fiber axis and the fiber coupling may be on roughly the same plane, with this plane being roughly parallel to the plane comprising the joint (pedestal joint) of the pedestal and the fiber support member (Mode 6). In particular, it is desirable for the optical fiber axis, fiber coupling, and pedestal joint to be on roughly the same plane.

Further, the semiconductor laser module of the present invention is characterized by being provided with the above-described optical fiber positioning structure.

### BRIEF DESCRIPTION OF THE FIGURES

FIG. 1 is a perspective view of a semiconductor laser module applying the optical fiber positioning structure of the present invention.

FIG. 2 is a lateral view of a semiconductor laser module applying the optical fiber positioning structure of the present invention.

FIG. 3 is a front view of both a type of fiber support member not comprising an elastic action flex member and a type of fiber support member comprising an elastic action flex member in the optical fiber positioning structure of the present invention.

FIG. 4 is a front view of another implementation mode in which a portion of the structure of the fiber support member has been modified in the optical fiber positioning structure of the present invention.

FIG. 5 presents perspective views of two types of conventional optical fiber holding structures and lateral views showing problems therein.

FIG. 6 is a cross-sectional view of an implementation mode of the rear fiber holding support member.

FIG. 7 is a model graph showing the transition of the level of deformation when horizontal stress is applied to a first notch formed in the rear fiber holding support member.

FIG. 8 is a cross-sectional view showing a further implementation mode of the rear fiber holding support member.

FIG. 9 is a cross-sectional view showing a still further implementation mode of the rear fiber holding support member.

FIG. 10 is a perspective view showing two implementation modes of the indentation formed in the pedestal.

FIG. 11 is an exploded perspective view showing an implementation mode in which the pedestal is comprised of multiple assembled parts in a sectional design.

FIG. 12 is a perspective view of an implementation mode of the position determining structure of the fiber holding member.

FIG. 13 is a lateral cross-sectional view of another implementation mode of the position determining structure of the fiber holding member.

FIG. 14 is a lateral cross-sectional view of still another implementation mode of the position determining structure of the fiber holding member.

FIG. 15 is a lateral cross-sectional view of still another implementation mode of the position determining structure of the fiber holding member.

FIG. 16 is a lateral cross-sectional view of still another implementation mode of the position determining structure of the fiber holding member.

FIG. 17 is a perspective view of a holding clip in which the extensions are of varying lengths.

FIG. 18 is a lateral cross-sectional view of still another implementation mode of the position determining structure of the fiber holding member.

### DETAILED DESCRIPTION OF THE INVENTION

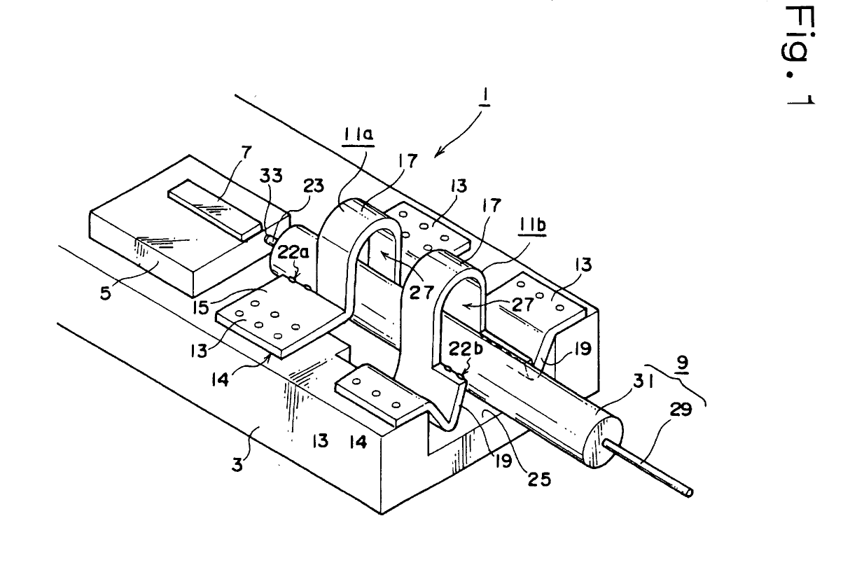

The present invention will be described in detail below based on the drawings. FIG. 1 is a perspective view of a preferred mode of a semiconductor laser module applying the optical fiber positioning structure of the present invention, with numeral 1 denoting a semiconductor laser module. Semiconductor laser module 1 is provided with a pedestal 3. On pedestal 3 is provided a semiconductor laser light source 7 through a light source pedestal 5. Light source pedestal 5 is fixed to pedestal 3, and semiconductor laser light source 7 is fixed to light source pedestal 5.

As employed herein, the term “fixed” does not mean that the positional relation between the two undergoes no change whatsoever, but is used in a manner covering, for example, the situation where correction exploiting contraction of the welded portion made by laser welding is conducted to slightly change the positional relation between the two.

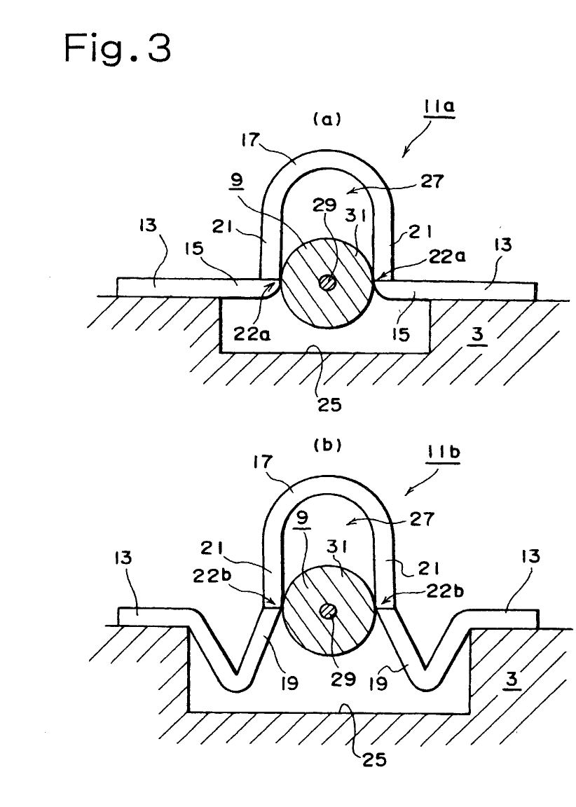

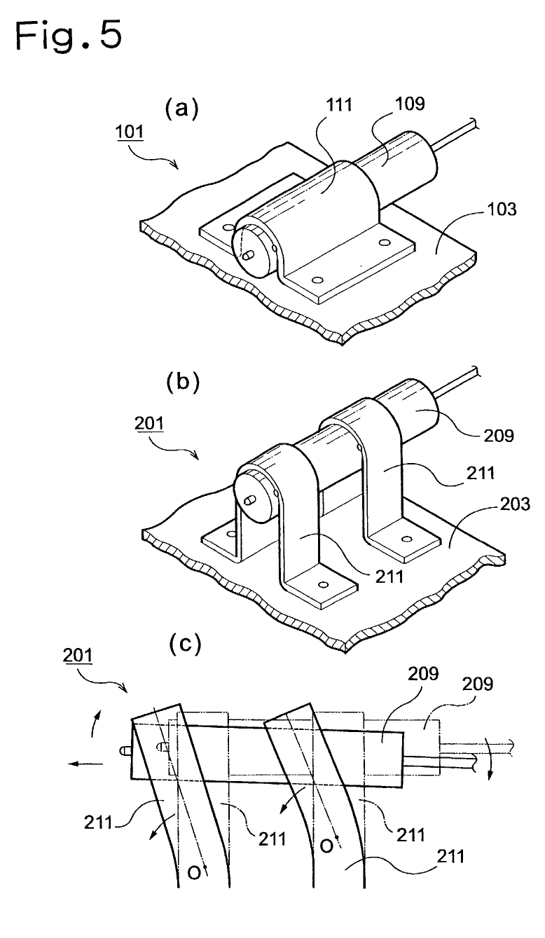

As employed herein, the term “fiber holding member” refers to a component of the fiber support member employed in joining the fiber support member and the optical fiber, that is formed independently from the other components of the fiber support member. As employed herein, the term “fiber coupling” refers to the surface portion of the fiber support member employed for joining to the optical fiber (for example, 22a and 22b in FIGS. 1-3). In the positioning structure of the present invention, the fiber holding member may be any component, but a fiber coupling is required. When the fiber support member has a fiber holding member, all or part of the surface of the fiber holding member becomes the fiber coupling. In FIG. 5, the inner wall portion of the laser-welded fiber support member corresponds to the fiber coupling.

As employed herein, the term “fixation member” refers to the component of the fiber support member employed to join the fiber support member to the pedestal (for example, 13 in FIGS. 1-3). Further, as employed herein, the term “pedestal joint” refers to the surface portion of the fiber support member employed for joining to pedestal. All or part of the surface of the fixation member of the fiber support member serves as the pedestal joint.

An indentation 25 is formed on the upper surface of pedestal 3. Indentation 25 has adequate depth to allow optical fiber 9 to move downward when optical fiber 9 is being held by the fiber support member, described further below, and to accept the shape of the fiber support member.

Two fiber support members 11a and 11b for holding optical fiber 9 are aligned in the axial direction of optical fiber 9 on the upper surface of pedestal 3. Each of fiber support members 11a and 11b is formed by bending a metal sheet inward or outward, and has fixation members 13 formed on the left and right ends. Fiber holding members 11a and 11b are fixed by means of fixation members 13 by laser welding through pedestal joint 14 to either side of indentation 25 of pedestal 3. Here, the length by which each of fiber holding members 11a and 11b extends upward from the upper surface of pedestal 3 will be described. As set forth above, since indentation 25 is formed on the upper surface of pedestal 3 in the present invention, as shown in the prior art of FIG. 5(c), even when the fiber support member is extended some distance upward from the upper surface of pedestal 3 to fix optical fiber 9 at a high position, adequate space for vertical movement of optical fiber 9 can be formed beneath optical fiber 9. Accordingly, during adjustment, the rocking back and forth of optical fiber 9 causing it to strike the semiconductor laser light source can be avoided in the present invention.

In fiber support member 11a on the side closest to semiconductor laser light source 7 are formed horizontal members 15 extending to the inside from each of fixation members 13 and a curved member 17 extending in the form of an inverted “U” upward from the two inner ends of horizontal members 15. Optical fiber 9 is held by being gripped from either side by fiber coupling 22a and is fixed by laser welding to the position of fiber coupling 22a.

In the present invention, the height of fiber coupling 22a as viewed from the bottom surface of the fixation member of fiber support member 11a is desirably equal to or less than ½ [sic: see claims 28, 29, 30], preferably equal to or less than ⅔, and more preferably, equal to or less than ½, the diameter of optical fiber 9. Further, the axis of the optical fiber is desirably positioned at the same height as, or lower than, the upper surface of fixation member 13 of the fiber support member. The lower limit is the lowest position at which it is possible to fix the optical fiber by laser welding (YAG, for example). However, the axis of the optical fiber is desirably at a position at the same height or higher than the lower surface of fixation member 13 of the fiber holding member. The height of the optical fiber axis and fiber coupling 22a can also be determined in light of the practical considerations of fixation by laser welding or the like. The height of the optical fiber axis and fiber coupling 22a can be made this low because of the formation of above-described indentation 25 in pedestal 3.

In the mode of FIG. 1, the optical fiber axis and fiber coupling 22a lie roughly on the same plane. Further, this plane and the plane comprising pedestal joint 14 are roughly parallel. By making these two planes roughly parallel, it is possible to substantially prevent vertical shifting relative to the pedestal surface. Further, when the optical fiber axis, fiber coupling, and pedestal joint are all on roughly the same plane, it is possible to strongly suppress shifting of the optical axis due to the heat cycle, aging, or change over time.

Optical fiber 9 is positioned within curved member 17 so as to form a space 27 there above. The presence of this space 27 allows optical fiber 9 to rotate about a rotation center O positioned near fiber coupling 22a of fiber support member 11a on the side closest to semiconductor laser light source 7.

Further, the fiber support member 11b positioned furthest from semiconductor laser light source 7 is provided with a fixation member 13, curved member 17, and fiber coupling 22b in the same manner as the fiber support member 11a positioned closest to semiconductor laser light source 7. Fiber coupling 22b is formed on the end furthest from semiconductor laser light source 7 of fiber support member 11b. Optical fiber 9 is held by being gripped by fiber coupling 22b and is fixed by laser welding to the position of fiber coupling 22b. The optical fiber axis and fiber coupling 22b lie on roughly the same plane, and this plane and the plane comprising pedestal joint 14 are roughly parallel.

In the present invention, the height of fiber coupling 22b as viewed from the lower surface of the fixation member of fiber support member 11b is desirably equal to or less than ½ [sic], preferably equal to or less than ⅔, and more preferably equal to or less than ½, the diameter of optical fiber 9. The optical fiber axis is desirably positioned at a height identical to or lower than the upper surface of fixation member 13 of the fiber support member. The lower limit is the lowest position at which it is possible to fix the optical fiber by laser welding. However, the axis of the optical fiber is desirably at a position at the same height or higher than the lower surface of fixation member 13 of the fiber holding member. The height of the optical fiber axis and fiber coupling 22b can also be determined in light of the practical considerations of fixation by laser welding or the like.

Fiber support member 11b, positioned furthest from semiconductor laser light source 7, differs from fiber support member 11a on the side closest to semiconductor laser light source 7 in that an elastic action flex member 19 that is “V” or “U” shaped in cross-section is provided between fixation member 13 and curved member 17. Elastic action flex member 19 functions to permit chiefly vertical positioning of optical fiber 9, but as required, also permits horizontal positioning of optical fiber 9.

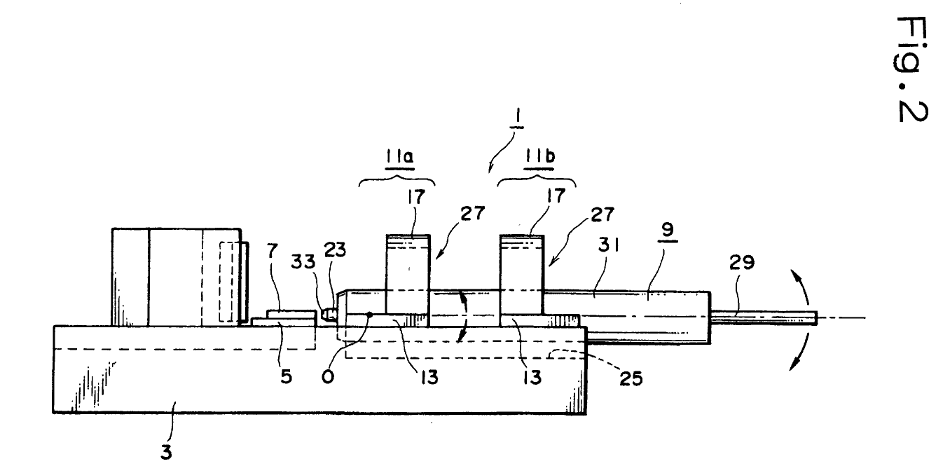

Combining two fiber support members 11a and 11b in this manner to hold optical fiber 9, as indicated by the arrow in FIG. 2, permits optical fiber 9 to rotate about center of rotation O. Positioning center of rotation O of optical fiber 9 near input end 23 of optical fiber 9 permits microadjustment at the input end of optical fiber 9 because it is possible to move the input end of optical fiber 9 very slightly during vertical displacement of the opposite end side (the side removed from input end 23) of input end 23 of optical fiber 9. When microadjustment of the input end of optical fiber 9 is possible by some other method, it is possible to position center of rotation O at a spot more removed from the input end of optical fiber 9. Further, center of rotation O is desirably positioned on or near the optical axis of optical fiber 9.

The method of correction employed when the optical axis of optical fiber 9 has shifted will be described next in combination with a schematic description of the structure of optical fiber 9.

Optical fiber 9 is comprised of a strand of fiber 29 in the center and a metal ferrule 31 formed thereabout. The configuration is such that a laser beam entering from input end 23 is received in the core of fiber strand 29 and progresses through optical fiber 9 while reflecting off the interface of the core and cladding.

A swollen lens element 33 that is concave on the semiconductor laser light source 7 side is formed in input end 23 of optical fiber 9. Lens element 33 functions to converge within the core of optical fiber 9 the laser beam from semiconductor laser light source 7, thereby increasing the entry efficiency of the laser beam.

When a vertical shift in the optical axis of optical fiber 9 occurs, it is possible to release an adjustment means, not shown, positioned on the side removed from the input end of optical fiber 9 and put optical fiber 9 in a state permitting adjustment. In this state, when optical fiber 9 near fiber coupling 22b of fiber support member 11b at a position removed from input end 23 is moved vertically, the fiber coupling 22b of fiber support member 11b at a position removed from input end 23 can be vertically displaced by about several millimeters due to the action of elastic action flex member 19.

With this vertical movement, optical fiber 9 rotates about center of rotation O, permitting the input end 23 of optical fiber 9 to be slightly displaced vertically. Since elastic action flex member 19 is positioned on fiber support member 11a on the input end 23 side, displacement of input end 23 is extremely small—on the micrometer level, for example. Such movement on the micro level permits adjustment of microshifting of the optical axis. Once such shifting of the optical axis has been corrected, optical fiber 9 is again secured by the fixing means, not shown, while maintaining the corrected state.

The semiconductor laser module 1 of the present invention is based on the above-described configuration, but is not limited thereto. Partial modification such as is described below is possible. For example, the input end of optical fiber 9 adjacent to semiconductor laser light source 7 was described in the above-described implementation mode, but the present invention can be applied to connection ends in an optical connection of separate optical fibers 9.

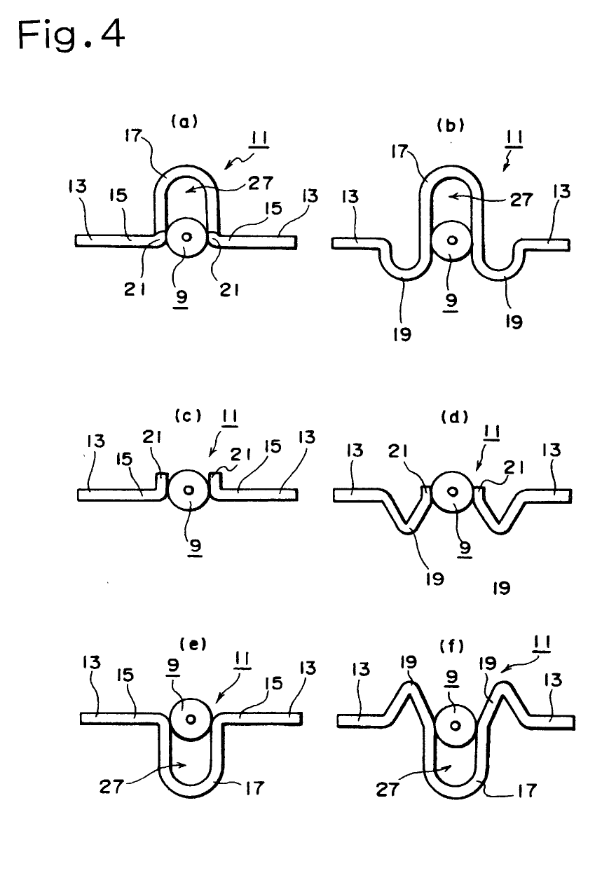

Further, the above-described modes of fiber support members 11a and 11b are not limited to those shown in FIGS. 1-3. For example, it is possible for there to be independent fiber holding members 21 as shown in FIGS. 4(a), (c), and (d).

Further, as shown in FIG. 4(b), there may also be an elastic action flex member 19 of “U”-shaped cross-section. Still further, as shown in FIGS. 4(c) and (d), it is also possible to employ a fiber support member 11 comprised of two members symmetrically positioned on left and right without a curved member 17. FIG. 4(c) shows a semiconductor laser module 1 in which no elastic action flex member 19 is provided. FIG. 4(d) shows a semiconductor laser module 1 in which an elastic action flex member 19 is provided.

Still further, as shown in FIG. 4(e) and (f), it is possible to employ a fiber support member 11 in which curved member 17 protrudes downward. FIG. 4(e) shows a semiconductor laser module 1 in which no elastic action flex member 19 is provided and FIG. 4(f) shows a semiconductor laser module 1 in which an elastic action flex member 19 is provided.

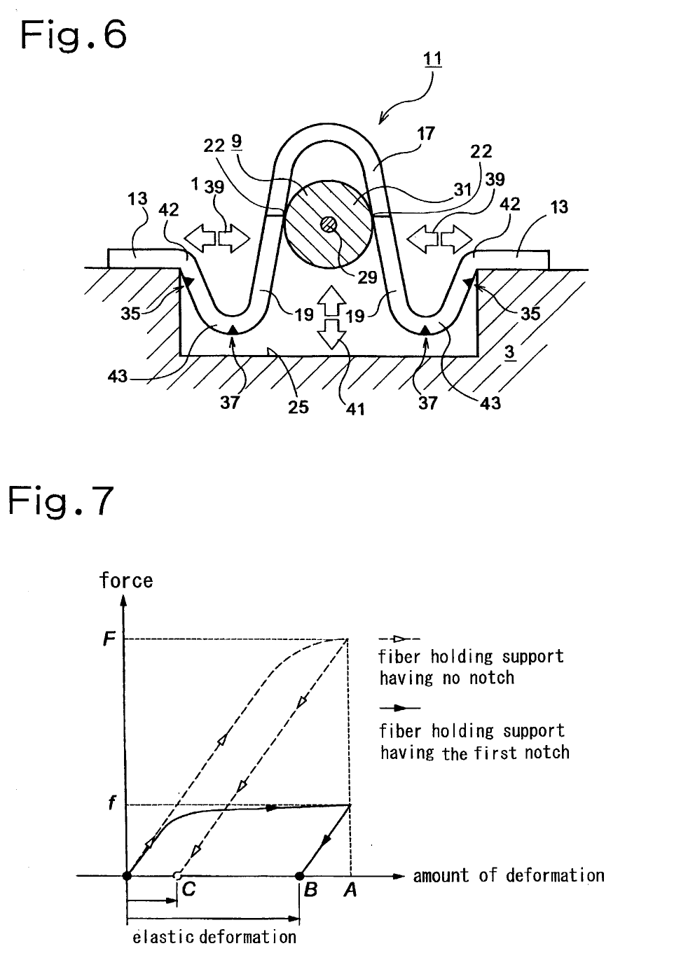

A stress concentrating member upon which pressure is more readily exerted than on adjacent portions is formed in said elastic action flex member. As shown in FIG. 6, when, after bending downward through first curved member 42 from the inner end of fixation member 13, elastic action flex member 19 turns upward through U-shaped second curved member 43 and arrives at extension fiber coupling 22, it is possible to form in advance, for example, a wedge-shaped first notch 35 to the outside directly below fixation member 13 along the perimeter of first curved member 42, and a wedge-shaped second notch 37 outside the lowermost end on the perimeter of second curved member 43. First curved member 42 and second curved member 43 are the spots where the most stress is concentrated when elastic action flex member 19 is subjected to a vertical or horizontal force. Such spots of stress concentration are defined as stress concentrating members herein. That is, the phrase “a stress concentrating member upon which pressure is more readily exerted than on adjacent portions” refers to a stress concentrating member which, by concentrating stress, permits even low nominal stress to exceed the yield stress of the material.

Forming wedge-shaped notches 35 and 37 in the stress concentration members produces the following results. When horizontal stress such as is indicated by the arrow 39 in FIG. 6 is exerted at the portion where first notch 35 is formed, the stress is concentrated and this portion tends to undergo plastic deformation. FIG. 7 is a model drawing showing the relation between the force exerted and the level of deformation when horizontal stress is exerted on deformation action member 19. This model drawing is represented as a model to facilitate understanding of the present invention and does not necessarily correctly represent the actual relation.

When the back end of metal ferrule 31 is pressed to exert stress f on elastic action flex member 19, as denoted by the solid line in FIG. 7, elastic action flex member 19 temporarily elastically deforms by precisely A (A>0), but once stress f has been eliminated, the amount of elastic deformation recovers slightly, and finally, plastic deformation of precisely B (0<B<A) is possible. When no notch is formed in the stress concentration member denoted by the solid line in FIG. 7, the amount of this plastic deformation B exceeds the amount of plastic deformation C when stress is eliminated after elastic deformation by precisely amount A.

As will be clear from FIG. 7, to achieve elastic deformation of precisely amount A, the stress f exerted when first notch 35 has been formed is smaller than the stress F applied when no notch is formed. For these reasons, when a horizontal stress applied to [elastic action flex member] 19, the amount of preliminary elastic deformation is smaller and the stress applied in that process is lower when first notch 35 has been formed than when no notch has been formed.

The portion in which second notch 37 is formed is a portion in which stress concentrates and plastic deformation tends to occur when vertical stress such as indicated by the arrow 41 in FIG. 6 is exerted. Further, since the same relation as that shown in FIG. 7 for first notch 35 is established for second notch 37, when vertical stress is applied to elastic action flex member 19 and a prescribed level of plastic deformation takes place, when second notch 37 has been formed, the amount of preliminary elastic deformation is smaller than when no notch has been formed, and less stress is applied in the process.

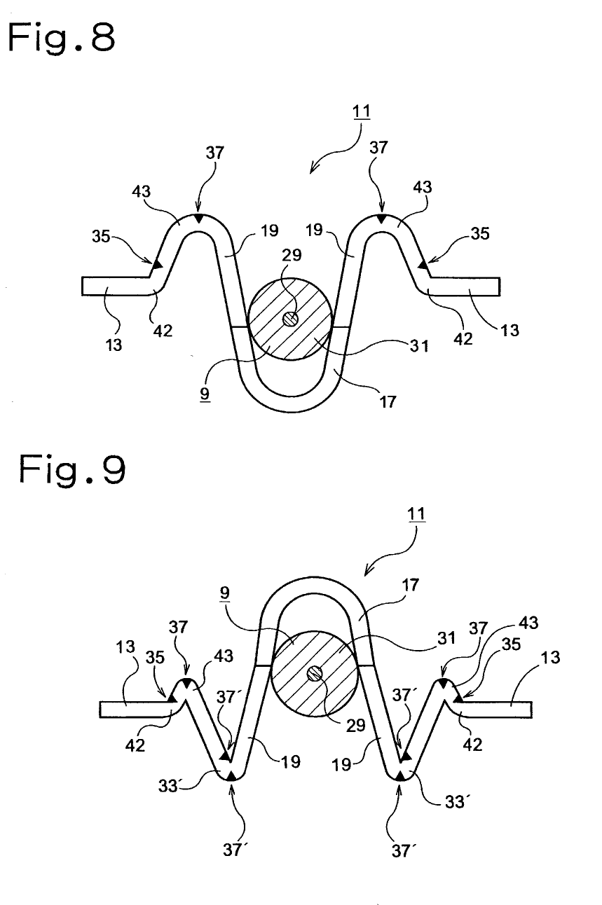

FIGS. 8 and 9 are further examples of ways of forming wedge-shaped notches.

In the modes of implementation of FIGS. 6, 8, and 9, a wedge-shaped notch is formed as the stress concentrating member in the curved member of elastic action flex member 19. However, a notch may be formed in any portion on which stress is actually exerted other than the curved portion. Further, the notch does not necessarily have to be wedge shaped, but need only be an indentation-like notch tending to deform more readily than other portions when stress is applied. Still further, the stress concentrating member, in addition to being formed by post-processing such as cutting a notch, may also be realized in the form of, for example, pressing at the outset of formation of the fiber support member. When a portion of the fiber support member is pressed to form the stress concentrating member, the thickness is desirably made about 50 percent of that of adjacent portions.

In the present invention, the number of fiber support members 11 is not limited to two, it being possible to provide just one or three or more. Further, the material of fiber support member 11 is not specifically limited other than that it have properties permitting the achievement of the object of the present invention; the use of metal is preferred.

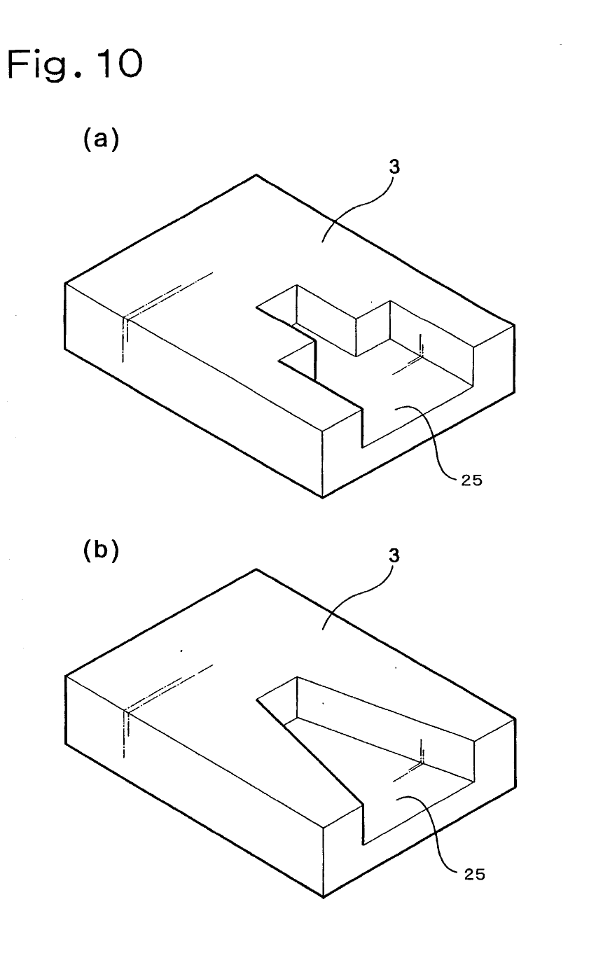

The cross-sectional shape of indentation 25 formed in pedestal 3 is not limited to the square channel shown in FIG. 1, but may be a “V”-shaped or “U”-shaped channel. Nor is the width of indentation 25 specifically limited. However, when multiple fiber support members are employed, the width is desirably made narrow on the front fiber holding support member side, growing wider toward the rear fiber holding support member side. For example, the width dimension of indentation 25 may be changed in step-like increments as shown in FIG. 10(a), or varied continuously in a wedge-like shape as shown in FIG. 10(b).

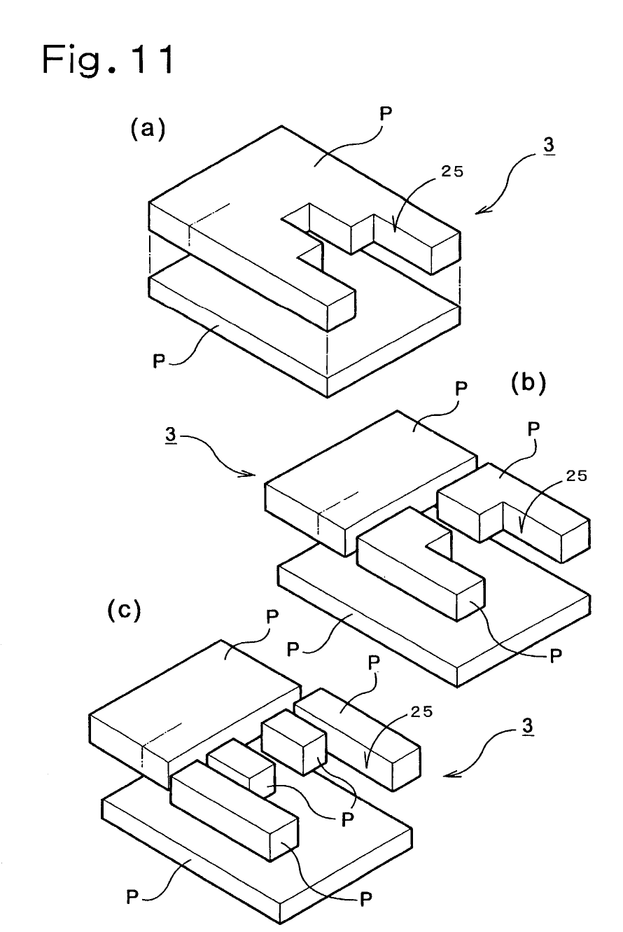

Indentation 25 is often formed by a cutting process employing engineering machinery such as a milling machine, laser processor, or the like, but these tend to result in high production costs. Accordingly, as shown in FIG. 11, a sectional pedestal 3 comprised of a number of parts P may be employed. In this preferred method, parts P are assembled and fastened with nuts and bolts, by welding, or the like to form pedestal 3 and indentation 25. FIG. 11(a) shows a pedestal 3 comprised of two sections in the form of an upper and a lower section. FIG. 11(b) shows a pedestal 3 comprising a total of four sections in which the upper section is further divided into three sections. FIG. 11(c) shows a pedestal 3 comprising a total of six sections in which the upper section is further divided into two and all the parts P are rectangular parallelepipeds. When employing such sectional pedestals 3, it is possible for each part P to be formed by relatively inexpensive punching in a press or the like.

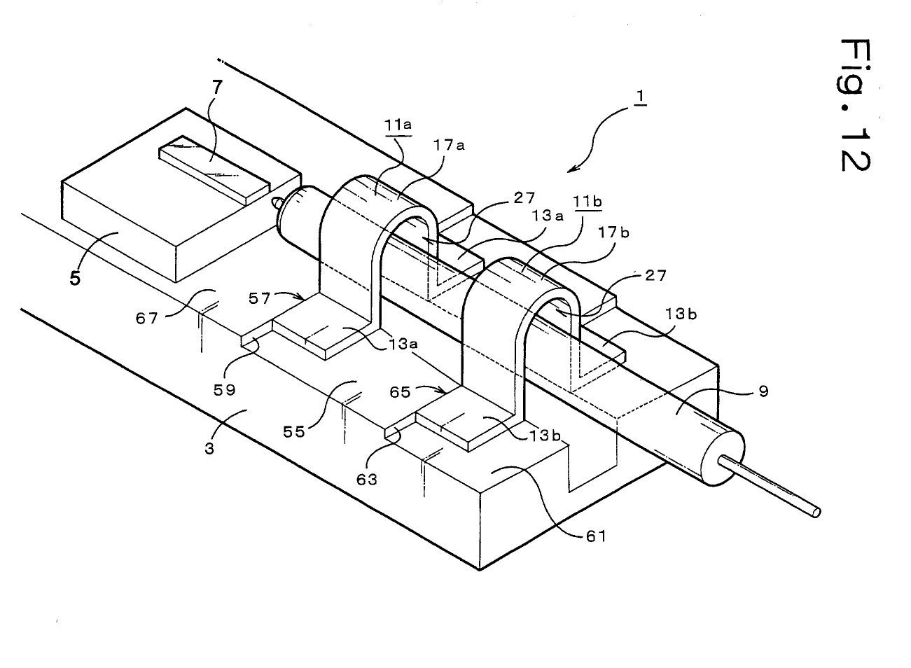

In the optical fiber positioning structure of the present invention, it is necessary to precisely position the fiber support members at prescribed spots on the pedestal. Thus, in the optical fiber positioning structure of the present invention, to increase the precision with which the fiber support members are positioned, structural characteristics such as those indicated in FIGS. 12-18 are desirably provided.

In FIG. 12, pedestal 3 is provided with a first fixation member support surface 55 supporting the lower surface of fixation member (first fixation member) 13a of the front fiber holding support member, and a first contact surface 59 capable of contacting the front end surface 57 of first fixation member 13. To the rear of first fixation member support surface 55 are provided a second fixation member support surface 61 supporting the lower surface of fixation member (second fixation member) 13b of the rear fiber holding support member, and a second contact surface 63 capable of contacting the front end surface 65 of second fixation member 13b. First contact surface 59 contacts front end surface 57 of first fixation member 13a, thereby permitting axial positioning of optical fiber 9 of front fiber holding support member 11a. Second contact surface 63 contacts front end surface 65 of second fixation member 13b, thereby permitting axial positioning of optical fiber 9 of rear fiber holding support member 11b.

The height of first contact surface 59 and second contact surface 63 is either desirably roughly identical to the thickness of first fixation member 13a and second fixation member 13b, or is such that only a small difference in level exists between each of fixation member support surfaces 55 and 62 and the upper surface of each of fixation members 13a and 13b. Establishing such a height relation permits laser beam welding across the area between the fixation members and the fixation member support surfaces, permitting stronger fixation of the two. However, such a height relation is not an essential element of the present invention. Even when the dimensions are set so that there is a large difference in level between the upper surfaces of individual fixation members 13a and 13b and individual fixation support surfaces 55 and 62, the effect of the present invention is unaltered.

In the mode of implementation shown in FIG. 12, light source support surface 67, which is higher than first fixation member support surface 55, is formed in front of first fixation member support surface 55 as a portion for the secure positioning of light source pedestal 5 for semiconductor laser light source 69. First contact surface 59 is formed at the boundary of light source support surface 67 and first fixation member support surface 55. First contact surface 59 may also be formed at the boundary between some surface formed for some other purpose in front of first fixation member support surface 55 and first fixation member support surface 55.

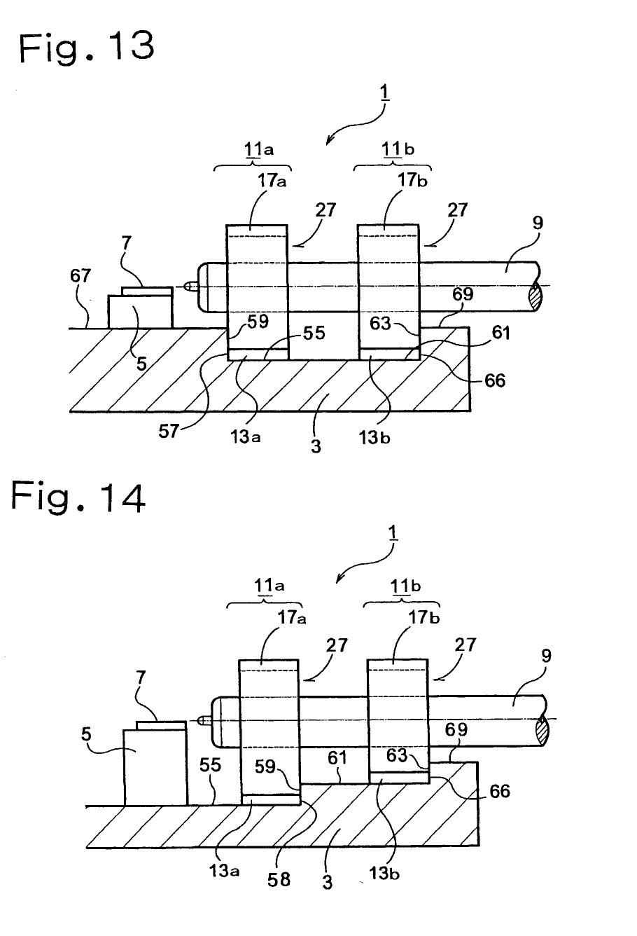

In the implementation mode shown in FIG. 13, front fiberholding support member and rear fiber holding support member 11b are positioned on the same plane. That is, first fixation member support surface 55 and second fixation member support surface 62 are coplanar.

Light source support surface 67 is formed at a position higher than first fixation member support surface 55 in front of first fixation member support surface 55, and third surface 69 is formed at a position higher than second fixation member support surface 61 behind second fixation member support surface 61. First contact surface 59 is formed at the boundary of first fixation member support surface 55 and light source support surface 67, and second contact surface 63 is formed at the boundary of second fixation member support surface 62 and third surface 69.

Having the front end surface 57 of first fixation member 13a in front fiber holding support member 11a contact first contact surface 59 permits axial positioning of optical fiber 9 of front fiber holding support member 11a, and having the rear end surface 66 of second fixation member 13b in rear fiber holding support member 111b contact second contact surface 63 permits the axial positioning of optical fiber 9 of rear fiber holding support member 11b.

In the implementation mode shown in FIG. 14, the form of pedestal 3, in contrast to the form of the implementation mode shown in FIG. 12, drops stepwise toward the front.

That is, the surface supporting light source pedestal 5 serves as first fixation member support surface 55, and second fixation member support surface 62, which is higher than first fixation member support surface 55, is formed to the rear of first fixation member support surface 55. Further, third surface 69, which is higher than second fixation member support surface 61, is formed to the rear of second fixation member support surface 61. First contact surface 59 is formed at the boundary between first fixation member support surface 55 and second fixation member support surface 62, and second contact surface 63 is formed at the boundary between second fixation member support surface 62 and third surface 69.

Having rear end surface 58 of first fixation member 13a in front fiber holding support member 11a contact first contact surface 59 permits axial positioning of optical fiber 9 of front fiber holding support member 11a, and having rear end surface 66 of second fixation member 13b in rear fiber holding support member 11b contact second contact surface 63 permits axial positioning of optical fiber 9 of rear fiber holding support member 11b.

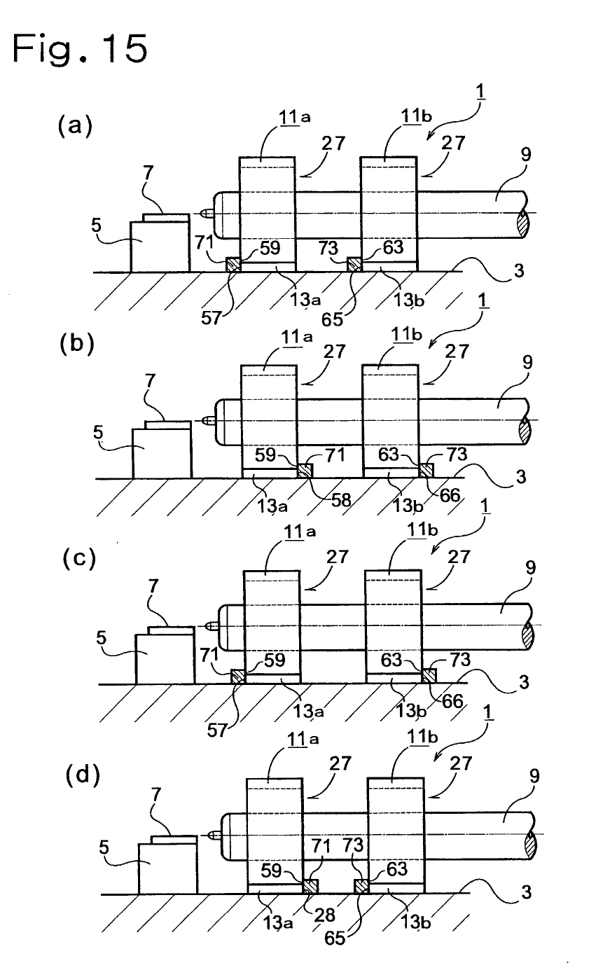

In the implementation mode shown in FIG. 15, two protrusions are formed on the upper surface of pedestal 3, which extends smoothly across the entire assembly. These protrusions provide first contact surface 59 and second contact surface 63, respectively.

That is, in the implementation mode shown in FIG. 15(a), first protrusion 71 is formed toward the front of the upper surface of flat pedestal 3, and second protrusion 73 is formed at a spot separated by a prescribed distance from and to the rear of first protrusion 71. First contact surface 59 is formed behind first protrusion 71. Having front end surface 57 of first fixation member 13a strike first contact surface 59 permits axial positioning of optical fiber 9 of front fiber holding support member 11a. Further, second contact surface 63 is formed to the rear of second protrusion 73. Having front end surface 65 of second fixation member 13b strike second contact surface 63 permits the axial positioning of optical fiber 9 of rear fiber holding support member 11b.

In the implementation mode shown in FIG. 15(b), the same first protrusion 71 and second protrusion 73 are formed in pedestal 3 as in the implementation mode of FIG. 15(a), and first contact surface 59 is formed in front of first protrusion 71. Having rear end surface 58 of first fixation member 13a contact first contact surface 59 permits axial positioning of optical fiber 9 of front fiber holding support member 11a. Second contact surface 63 is formed in front of second protrusion 73. Having back end surface 66 of second fixation member 13b contact second contact surface 63 permits axial positioning of optical fiber 9 of rear fiber holding support member 11b.

In the implementation mode shown in FIG. 15(c), first protrusion 71 and second protrusion 73 are formed in pedestal 3 and first contact surface 59 is formed to the rear of first protrusion 71. Having front end surface 57 of first fixation member 13a contact first contact surface 59 permits axial positioning of optical fiber 9 of front fiber holding support member 11a. Further, second contact surface 63 is formed in front of second protrusion 73. Having rear end surface 66 of second fixation member 13b contact second contact surface 63 permits axial positioning of optical fiber 9 of rear fiber holding support member 11b.

In the implementation mode shown in FIG. 15(d), first protrusion 71 and second protrusion 73 are formed in pedestal 3. First contact surface 59 is formed in front of first protrusion 71. Having rear end surface 58 of first fixation member 13a contact first contact surface 59 permits axial positioning of optical fiber 9 of front fiber holding support member 11a. Further, second contact surface 63 is formed to the rear of second protrusion 73. Having front end surface 65 of second fixation member 13b contact second contact surface 63 permits axial positioning of optical fiber 9 of rear fiber holding support member 11b.

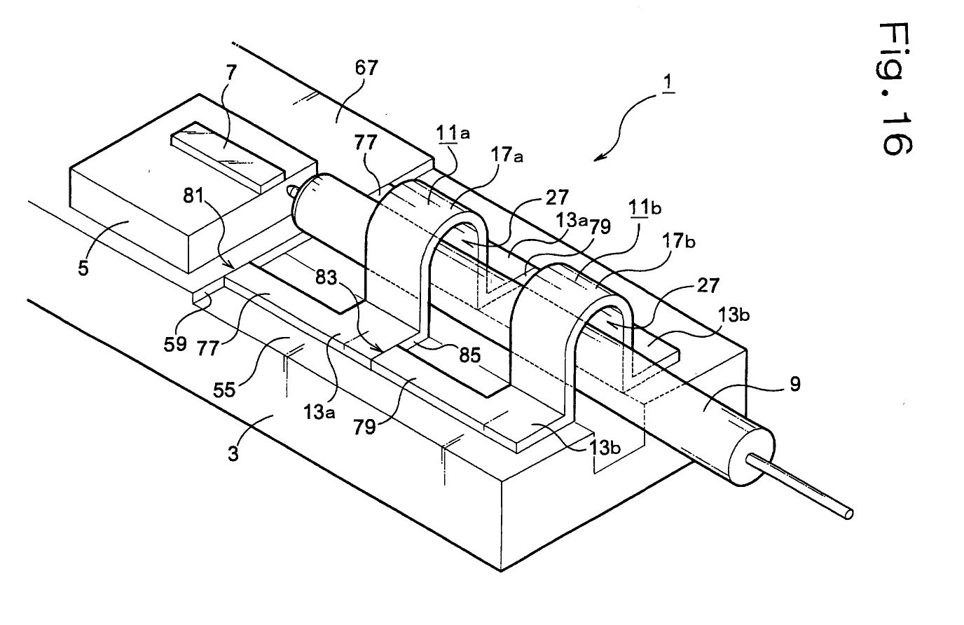

In the implementation mode shown in FIG. 16, front fiber holding support member 1 la and rear fiber holding support member 11b are positioned on the same fixation support surface 55 of pedestal 3. Front fiber holding support member 1 la is provided with a first fixation member 13a and a first curved member 17a, as well as a first extension 77 extending forward from the front end of first fixation member 13a. Having the front end surface 81 of first extension member 77 contact the contact surface 59 formed at the boundary of light source support surface 67 and fixation member support surface 55 permits the axial positioning of optical fiber 9 of front fiberholding support member 11a.

Rear fiber holding support member 11b is provided with a second fixation member 13b and a second curving member 17b, as well as a second extension 79 extending forward from the two ends of second fixation member 13b. Having the front end surface 83 of second extension 79 contact the rear end surface 85 of first fixation member 13a in front fiber holding support member 11a permits axial positioning of optical fiber 9 of rear fiber holding support member 11b.

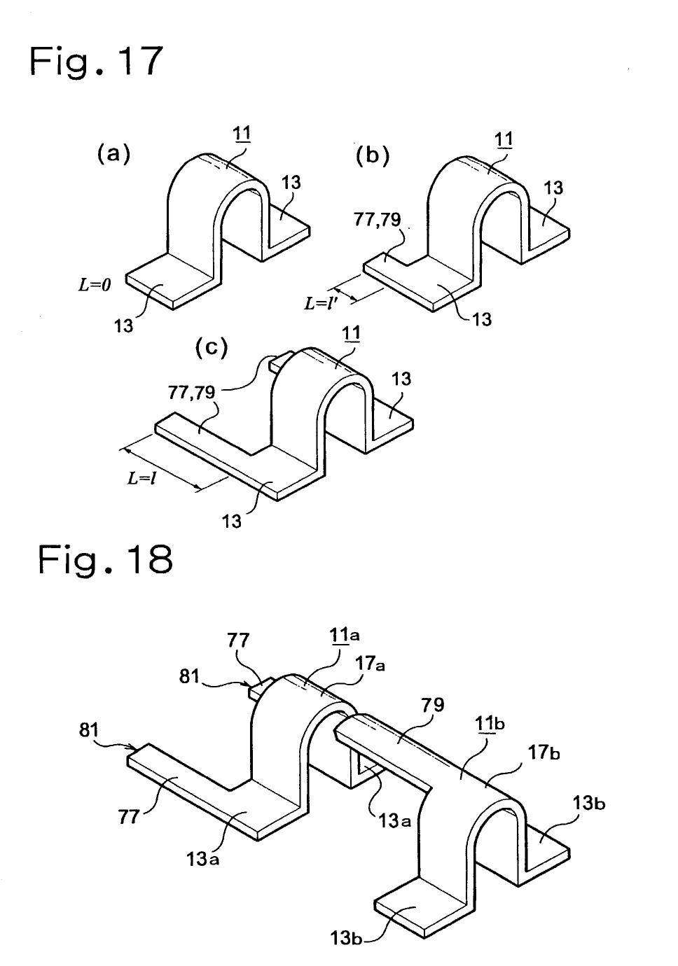

In this implementation mode, as shown in FIG. 17, fiber support members of various different lengths L of each of extensions 77 and 79 in front fiber holding support member and rear fiber holding support member 11b can also be provided. Thus, the axial holding position of optical fiber 9 by front fiberholding support member and rear fiber holding support member 11b can be varied, the optical output can be measured, and the fiber support member yielding the highest optical output can be selected.

Although not shown, it is also possible to form a rearward extension from first fixation member 17a of front fiberholding support member, and have the rear end surface of the rearward extension contact the front end surface of second fixation member 13b of rear fiber holding support member 11b on which no extension has been formed to permit positioning of rear fiber holding support member 11b. It is also possible for the rear end surface of a rearward extension from first fixation member 13a of front fiberholding support member and the front end surface of a forward extension from second fixation member 13b of rear fiber holding support member 11b to contact each other, permitting the positioning of rear fiber holding support member 11b.

The implementation mode shown in FIG. 18 will be described. In this example, the form of front fiberholding support member is identical to that in the implementation mode of FIG. 16. Second extension 79 formed on rear fiber holding support member 11b extends forward from second curved member 17b, not from second fixation member 13b. Having the front end surface of second extension 79 contact the rear end surface of first curved member 17a of front fiberholding support member permits the axial positioning of optical fiber 9 of rear support fiber holding member 11b.

As a modification of this mode of implementation, a rearward extension can be formed from first curved member 17a of front fiberholding support member, and the rear end surface of the rearward extending member can contact the front end surface of second curved member 17b of rear fiber holding support member 11b, on which no extension has been formed, to position rear fiber holding support member 11b. Further, the rear end surface of a rearward extension from first curved member 17a of front fiberholding support member and a front end surface of a forward extension from second curved member 17b of rear fiber holding support member 11b can be made to contact each other, permitting positioning of rear fiber holding support member 11b.

Potential for Industrial Application

Based on the optical fiber positioning structure of the present invention, since an indentation is formed on the upper surface of the pedestal, even without significantly extending upward the fiber support member from the upper surface of the pedestal to secure optical fiber 9 at an elevated position as is conventionally done, adequate space can be formed below the optical fiber for vertical displacement of the optical fiber. Accordingly, based on the present invention, the front and back rocking of the optical fiber and striking of the semiconductor laser light source can be avoided during adjustment. Further, since the optical fiber is held with at least vertical space ensured in the fiber coupling, it is possible to rotate the optical fiber at least vertically and perform vertical adjustment. Still further, vertical displacement of the opposite side from the end of the optical fiber being positioned permits rotation about a center of rotation at a point near the end being positioned, resulting in only slight movement of the end being positioned even when the opposite side from the end being positioned is moved by a comparatively large amount, and thereby permitting microadjustment on the end being positioned. Further, since the fixation point of the fiber support member and the fiber holding member connecting the fiber support member and the fiber are on roughly the same plane, even when changes in stress due to heat and the like of the fiber support member occur, changes in moment and the like tend not to occur and positional shifting of the fiber and the like tend not to occur.

Based on Mode 1 of the present invention, since the center of rotation is positioned on or near the axis of the optical fiber, when the opposite side from the positioning end is displaced, the direction of displacement of the end being positioned and the displacement distance can be readily estimated or calculated, facilitating optical fiber positioning.

Based on Mode 2 of the present invention, vertical displacement of the fiber support member on the side furthest from the input end or connection end of the optical fiber permits microdisplacement of the input end or connection end of the optical fiber, thereby permitting microadjustment of the optical fiber.

Based on Mode 3 of the present invention, the relative positioning of the optical fiber and fiber support member is not changed, but the optical fiber can be displaced on the side furthest from the input end or connection end of the optical fiber.

Based on Mode 4 of the present invention, even without extending the fiber support member far upward, it is possible to form space above and below the optical fiber, and displacement is possible within this space to position the optical fiber. Further, since the rigidity of the fiber support material is increased, shifting of the optical axis due to the heat cycle, aging, or change over time is strongly inhibited.

Based on Mode 5 of the present invention, movement of the optical fiber to the front and rear during vertical positioning of the optical fiber can be inhibited. Further, the center of rotation can be readily set at a point close to the end of the optical fiber being positioned.

Based on Mode 6 of the present invention, it is possible to inhibit vertical movement of the optical fiber relative to the pedestal surface. In particular, when the axis of the optical fiber, fiber coupling, and pedestal joint all lie on roughly the same plane, shifting of the optical axis due to the heat cycle, aging, or over time is strongly inhibited, almost never occurring in practical terms.

Based on the semiconductor laser module of the present invention, micropositioning of the optical fiber at the input end or connection end is possible and operational properties relating to positioning are good.

1. An optical fiber positioning structure in which are provided a fiber support member capable of holding an optical fiber in a fiber coupling and a pedestal supporting said fiber support member, there being in said pedestal an indentation having a depth permitting said optical fiber to move downward, said optical fiber being held in said fiber coupling in a state ensuring space at least above and below, and it being possible to move the side opposite the end of the optical fiber being positioned vertically to rotate about a rotation center at a point near said end being positioned and displace by minute amounts said end being positioned.

2. The optical fiber positioning structure according to claim 1 wherein said rotation center is provided at a position on or near the axis of the optical fiber.

3. The optical fiber positioning structure according to claim 1 wherein two fiber support members are positioned on said pedestal along the axis of said optical fiber, the front fiberholding support member on the side near the input end or connection end of said optical fiber holding in a nearly fixed manner the position of the optical fiber, and the rear fiber holding support member furthest from the input end or connection end of said optical fiber holding said optical fiber during positioning of the optical fiber in a manner permitting displacement of the optical fiber.

4. The optical fiber positioning structure according to claim 3 wherein an elastic action flex member is formed in said rear holding fiber support member between a pedestal fixation member and the fiber coupling.

5. The optical fiber positioning structure according to claim 4 wherein a stress concentrating member upon which pressure is more readily exerted than on adjacent portions is formed in said elastic action flex member.

6. The optical fiber positioning structure according to claim 5 wherein said elastic action flex member, after being bent through a first flex member by said pedestal fixation member, is extended in the opposite direction by a second flex member and brought into contact with said fiber coupling.

7. The optical fiber positioning structure according to claim 6 wherein said stress concentrating member is formed along the perimeters of said first flex member and said second flex member.

8. The optical fiber positioning structure according to claim 5 wherein said stress concentrating member is formed by making a notch in a sheet comprising the rear fiber holding support member.

9. The optical fiber positioning structure according to claim 8 wherein said notch is wedge-shaped.

10. The optical fiber positioning structure according to claim 5 wherein said stress concentrating member is formed close against the plate comprising the rear fiber holding support member.

11. The optical fiber positioning structure according to claim 3 wherein said front fiberholding support member and said rear fiber holding support member are separate, independent members.

12. The optical fiber positioning structure according to claim 3 wherein said front fiber holding support member and said rear fiber holding support member are connected into a single integrated member.

13. The optical fiber positioning structure according to claim 1 wherein the fixation members of the fiber support members are fixed on the two sides of said indentation relative to the axis of said optical fiber.

14. The optical fiber positioning structure according to claim 13 wherein the width dimension of the indentation formed in said pedestal is set so as to be narrow on the front fiber holding support member side and become wider on the rear fiber holding support member side.

15. The optical fiber positioning structure according to claim 13 wherein said pedestal is provided with a fixation member support surface supporting the bottom surface of the fixation member of the fiber support member, and a contact surface contacting the front end surface and/or back end surface of the fiber support members and determining the fiber axis direction position of the fiber support members.

16. The optical fiber positioning structure according to claim 14 wherein said pedestal is provided with a first fixation member support surface supporting the bottom surface of the fixation member of the front fiber holding support member, and a first contact surface contacting the front end surface and/or back end surface of the front fiber holding support member and determining the fiber axis direction position of the front fiber holding support member, and a second fixation member support surface supporting the bottom surface of the fixation member of the rear fiber holding support member, and a second contact surface contacting the front end surface and/or back end surface of the rear fiber holding support member and determining the fiber axis direction position of the front [sic] fiber holding support member.

17. The optical fiber positioning structure according to claim 16 wherein a light source support surface for the positioning of a semiconductor laser light source is formed on said pedestal at a position higher than said first fixation member holding surface, said first contact surface is formed at the boundary of said light source support surface and said first fixation member support surface, said second fixation member support surface is formed at a position lower than said first fixation member support surface, and said second contact surface is formed at the boundary of said first fixation member support surface and said second fixation member support surface.

18. The optical fiber positioning structure according to claim 16 wherein said first fixation member support surface and said second fixation support surface are positioned on a single flat surface, a light source support surface for the positioning of a semiconductor laser light source is formed at a position higher than said first fixation member support surface in front of said first fixation member support surface, a third surface higher than said second fixation member support surface is formed to the rear of said second fixation member support surface, said first contact surface is formed at the boundary of said first fixation member support surface and said light source support surface, and said second contact surface is formed at the boundary of said second fixation member support surface and said third surface.

19. The optical fiber positioning structure according to claim 16 wherein said second fixation member support surface is formed at a position higher than said first fixation member support surface to the rear of said first fixation member support surface, a third surface higher than said second fixation member support surface is formed to the rear of said second fixation member support surface, said first contact surface is formed at the boundary of said first fixation member support surface and said second fixation member support surface, and said second contact surface is formed at the boundary of said second fixation member support surface and said third surface.

20. The optical fiber positioning structure according to claim 16 wherein said first fixation member support surface and said second fixation member support surface lie on a single plane, and a first protrusion on which is formed said first contact surface and a second protrusion on which is formed said second contact surface and which is positioned to the rear of said first protrusion are formed on said plane.

21. The optical fiber positioning structure according to claim 15 wherein said pedestal is provided with a first fixation member support surface supporting the bottom surface of the fixation member of the front fiber holding support member, a second fixation member support surface supporting the bottom surface of the fixation member of the rear fiber holding support member, and a contact surface contacting the front end surface of some portion of said front fiber holding support member and determining the position in the optical fiber axial direction of said front fiber holding support member, and said rear fiber holding support member is provided with a front end surface contacting the rear end surface of some portion of said front fiber holding support member and determining the position in the optical fiber axial direction of said rear fiber holding support member.

22. The optical fiber positioning structure according to claim 21 wherein a portion of said rear fiber holding support member is extended forward to form an extension and the front end surface of said extension contacts the rear end surface at a position corresponding to said rear fiber holding support member and determines the position in the optical fiber axial direction of said rear fiber holding support member.

23. The optical fiber positioning structure according to claim 21 wherein a portion of said front fiber holding support member is extended rearward to form an extension and the rear end surface of said extension contacts the front end surface at a position corresponding to said rear fiber holding support member and determines the position in the optical fiber axial direction of said rear fiber holding support member.

24. The optical fiber positioning structure according to claim 21 wherein a portion of said front fiber holding support member is extended rearward to form an extension, a portion of said rear fiber holding support member is extended forward to form an extension, and the rear end surface of the extension in said front fiber holding support member and the front end surface of the extension in said rear fiber holding support member come into contact with each other to determine the position of said rear fiber holding support member in the optical fiber axial direction.

25. The optical fiber positioning structure according to claim 22 wherein the extension in said front fiber holding support member or rear fiber holding support member extends from the fixation member of said front fiber holding support member or from the fixation member of said rear fiber holding support member.

26. The optical fiber positioning structure according to claim 22 wherein the extension in said front fiber holding support member or rear fiber holding support member extends from a portion other than the fixation member of said first fiber support member or from a portion other than the fixation member of said second fiber support member.

27. The optical fiber positioning structure according to claim 22 wherein multiple front fiber holding support members or rear fiber holding support members are provided for switching out different lengths of the extension in said front fiber holding support member or rear fiber holding support member.

28. The optical fiber positioning structure according to claim 13 wherein the height of the fiber coupling of said fiber holding support member as viewed from the bottom surface of the fixation members of said fiber holding members is less than the diameter of said optical fiber.

29. The optical fiber positioning structure according to claim 28 wherein the height of the fiber coupling of said fiber holding support member as viewed from the bottom surface of the fixation member of said fiber holding members is equal to or less than ⅔ the diameter of said optical fiber.

30. The optical fiber positioning structure according to claim 29 wherein the height of the fiber coupling of said fiber holding support member as viewed from the bottom surface of the fixation member of said fiber holding members is equal to or less than ½ the diameter of said optical fiber.

31. The optical fiber positioning structure according to claim 30 wherein the axis of said optical fiber is positioned lower than the bottom surface of the fixation member of said fiber support member.

32. The optical fiber positioning structure according to claim 28 wherein the axis of said optical fiber is positioned higher than the bottom surface of the fixation member of said fiber support member.

33. The optical fiber positioning structure according to claim 1 wherein said optical fiber axis and said fiber coupling are present on roughly the same plane, and said plane is roughly parallel with a plane comprising the joint of said pedestal and said fiber support member.

34. The optical fiber positioning structure according to claim 1 wherein the axis of said optical fiber, said fiber coupling, and the joint of said pedestal and said fiber support member lie on roughly the same plane.

35. The semiconductor laser module provided with the optical fiber positioning structure of claim 1.
